(19) United States
(12) Patent Application Publication
(10) Pub. No.: US 2015/0139295 A1
(43) Pub. Date: May 21, 2015

(54) DIGITAL VIDEO ENCODING METHOD

(71) Applicant: Vadim Vitalievich Yaroshenko, Moscow (RU)

(72) Inventor: Vadim Vitalievich Yaroshenko, Moscow (RU)

(21) Appl. No.: 14/411,984

(22) PCT Filed: Jul. 4, 2013
(86) PCT No.: PCT/RU13/00569

§ 371 Date: Dec. 30, 2014

(30) Foreign Application Priority Data
Jul. 5, 2012 (RU) 2012127891

(51) Int. Cl. H04N 19/119; H04N 19/136; H04N 19/176

(52) U.S. Cl. CPC H04N 19/119; H04N 19/176; H04N 19/136
USPC 375/240.02

(57) ABSTRACT

A method for encoding a digital video image producing a high resolution is proposed. A source digital video image is segmented into a plurality of video frames and each such frame is segmented into a plurality of blocks composed of pixels. An encoded digital video image is formed from a sequence of the frames. Each subsequent frame is added to the encoded image if the frame is entirely different from the previous frame. If a subsequent frame repeats the previous frame, then a command is added to repeat the previous video frame. If a subsequent frame is not entirely different, then a command is added to the encoded image to repeat the previous frame taking into account the differing blocks. The pixels in the encoded image are formed having a square shape, regardless of their compression ratio. The encoded image can be saved to at least one media server.

### CROSS-REFERENCE TO RELATED APPLICATIONS

This application is a U.S. national phase application of a PCT application PCT/RU2013/000569 filed on 4 Jul. 2013, published as WO2014/007683, whose disclosure is incorporated herein in its entirety by reference, which PCT application claims priority of a Russian Federation patent application RU2012127891 filed on 5 Jul. 2012.

### FIELD OF THE INVENTION

This invention pertains to methods of digital video encoding and can be used for efficient encoding of video data in video file formats, as well as in stream and broadcast video formats.

### BACKGROUND OF THE INVENTION

A digital image, such as video, TV image, static image or image generated using a VCR or PC, contains pixels located along horizontal and vertical lines. One image frame usually contains tens of thousands pixels. Each pixel usually contains information on brightness and color. An unencrypted digital image contains a significant amount of information. A number of encoding methods, such as the JPEG, MPEG, and H.263 standards, were developed in order to decrease the amount of data to be transferred.

A typical video encoder divides the frames of a source video sequence into rectangular areas or blocks that are encoded in an internal or intermediate mode. The blocks are encoded independently, using a certain type of transformation coding, such as Discrete Cosine Transformation (DCT) method.

However, the encoding involving a division of the frames of the source video sequence into the aforementioned rectangular areas or blocks has some disadvantages. One of these disadvantages is quality loss of the digital video image.

### BRIEF SUMMARY OF THE INVENTION

According to the present invention, a method for encoding a digital video is proposed. The method employs a video encoder, and comprises the steps of:—providing a source digital video;—dividing and processing said source digital video essentially into a sequence of video frames;—dividing each of the video frames into a set of pixel blocks;—for said sequence of video frames, subsequently defining a previous video frame and a subsequent video frame that immediately follows the previous video frame;—encoding said digital video based on said sequence of video frames, according to the following rules: a) if all of the pixel blocks of said subsequent video frame are completely different from the corresponding pixel blocks of said previous video frame, then said subsequent frame is added by the video encoder to the encoded video; b) if all of the pixel blocks of said subsequent video frame are identical to all of the corresponding pixel blocks of said previous video frame, then a command is issued by the video encoder to repeat the previous frame to be added to the digital video; c) if not all, but a number of the pixel blocks of said subsequent video frame are different from the corresponding pixel blocks of the previous video frame, then a command is issued by the video encoder to repeat the previous frame to be added to the digital video, with respective changes to said number of the pixel blocks; and d) the video encoder generates said pixels with a square shape.

According to the present invention, the above-describe method for encoding a digital video may include the following additional steps: said digital video is displayed on a rectangular display device having two display sides, and characterized by a display aspect ratio of the display sides; said video frames, each having two frame sides, are characterized by a frame aspect ratio of the frame sides; the frame aspect ratio is set to be a multiple of the display aspect ratio; and the multiple can be either an integer or a fractional number.

According to the present invention, the above-describe method for encoding a digital video may include the following additional step: the encoded video is saved on at least one media server.

### DETAIL DESCRIPTION OF PREFERRED EMBODIMENT OF THE INVENTION

While the invention may be susceptible to embodiment in different forms, there will be described in detail herein, a specific embodiment of the present invention, with the understanding that the present disclosure is to be considered an exemplification of the principles of the invention, and is not intended to limit the invention to that as described herein.

A result provided by the claimed invention is aimed at increasing the quality of the digital video obtained by encoding the source digital video.

This result is achieved by encoding the source digital video, where the source digital video can be provided in any formats and with any resolutions (exceeding the typically required ones), e.g.:
Apple ProRes 4444
Apple ProRes 422 (HQ)
Apple ProRes 422
Apple ProRes 422 (LT)
Apple ProRes 422 (Proxy)
Full HD (1920×1080)
HD (1280×720) etc.

The inventive method comprises several stages described herein below:

At an encoding stage, a source digital video is divided into a set of video frames further processed into a sequence of video frames, and each such video frame from this set of video frames is divided into a set of blocks consisting of pixels.

At least one encoded video is generated from the video frame sequence according to the following procedure:
Every subsequent frame is added by the video encoder to the encoded video, if it is completely different from the previous video frame.
If every subsequent video frame repeats the previous video frame, then a command by the video encoder is issued to repeat the previous frame is added to the digital video being generated, instead of the subsequent video frame.
If every subsequent video frame partially repeats the previous video frame, then a command by the video encoder is issued to repeat the previous frame with consideration of pixel differences inside the blocks of the previous and subsequent frames is added to the digital video being generated.
The encoding is carried out in such a way as to keep a square pixel shape in the encoded video, regardless of a compression ratio of the encoded video to the source digital video.
An encoded digital video is typically displayed on a display device characterized by an aspect ratio of the display device's sides. In an encoded digital video, a video frame is also characterized by an aspect ratio of the frame's sides. The aspect ratio of a video frame can be arbitrary, if the pixels' shape remains to be a square. However, it is recommended to make the video frame's aspect ratio of the encoded video to be a multiple of the aspect ratio of the display device, in order to ensure an optimum quality of the digital video. In this case, the multiple can be either an integer or a fractional number.
If the pixel shape remains to be a square, then the encoded digital image bit rate can be substantially decreased, regardless of the compression ratio, without any quality loss of the encoded digital image, hence, it is possible to considerably decrease the encoded digital image file size, which is directly proportional to the bit rate (File size=Bit rate×File length) without quality loss.

The obtained encoded video can be saved on at least one media server.

An example of the video frame aspect ratio multiplicity in encoded digital video with respect to video frame size of the Full HD display device (1920×1080) is given in the following table:

TABLE 1

| Resolution | Relation to FULL HD |
|---|---|
| 1920 × 1080 | 1 Full HD resolution |
| 1280 × 720 | ½ Full HD resolution |
| 1024 × 576 | 1/3.52 Full HD resolution |
| 960 × 540 | ¼ Full HD resolution |
| 640 × 360 | 1/9 Full HD resolution |
| 480 × 270 | 1/16 Full HD resolution |
| 320 × 180 | 1/36 Full HD resolution |
| 240 × 135 | 1/64 Full HD resolution |

If the pixel shape remains to be a square in the encoded digital video, and the video frame aspect ratio of the encoded digital video picture corresponds to the video frame size of the Full HD display device (1920×1080), it is possible to achieve the claimed technical result, which allows:
Displaying the encoded digital video of an optimum quality on any device type that supports such view, since this method covers the most popular technical platforms, such as a smartphone, tablet PC, laptop, desktop monitor, TV screen, etc.
Deliver the encoded digital video of high resolution and an optimum quality to the user at low data transfer rates, e.g.:

a) Full HD (1920×1080) at transfer rate less than 5 Mbit/s;

b) HD (1280×720) at transfer rate less than 2 Mbit/s;

c) etc.

All of the method stages disclosed in this invention can be explicitly implemented by means of computers, or as a software (SW) module executed by a CPU. SW module can be stored in RAM, flash memory, ROM, permanent memory, EROM, EEPROM, register, on hard disc, removable disc, CD-ROM, or any other existing storage media. On the other hand, storage medium can be integrated into a CPU. The CPU and storage medium can be located in a specialized integrated circuit. The specialized integrated circuit can be located in a user terminal. Alternatively, the storage medium and CPU can be located in a user terminal as individual components.

The digital video encoding method disclosed in this invention comprises several stages or actions implementing the described method. The sequence of the stages or actions can be changed without going beyond the scope of this invention.

A skilled artisan should understand that this method is not limited by specific stages and actions revealed in this invention.

1. A method for encoding a digital video employing a video encoder, said method comprising the steps of:
providing a source digital video;
dividing and processing said source digital video essentially into a sequence of video frames:
dividing each of the video frames into a set of pixel blocks;
for said sequence of video frames, subsequently defining a previous video frame and a subsequent video frame that immediately follows the previous video frame;
encoding said digital video based on said sequence of video frames, according to the following rules:
a) if all of the pixel blocks of said subsequent video frame are completely different from the corresponding pixel blocks of said previous video frame, then said subsequent frame is added by the video encoder to the encoded video;
b) if all of the pixel blocks of said subsequent video frame are identical to all of the corresponding pixel blocks of said previous video frame, then a command is issued by the video encoder to repeat the previous frame to be added to the digital video;
c) if not all, but a number of the pixel blocks of said subsequent video frame are different from the corresponding pixel blocks of the previous video frame, then a command is issued by the video encoder to repeat the previous frame to be added to the digital video, with respective changes to said number of the pixel blocks; and
d) the video encoder generates said pixels with a square shape.

2. The method according to claim 1, wherein:
said digital video is displayed on a rectangular display device having two display sides, and characterized by a display aspect ratio of the display sides;
said video frames, each having two frame sides, are characterized by a frame aspect ratio of the frame sides;
the frame aspect ratio is set to be a multiple of the display aspect ratio; and
the multiple can be either an integer or a fractional number.

3. The method according to claim 1, wherein: the encoded video is saved on at least one media server.
